(19) United States
(12) Patent Application Publication
(10) Pub. No.: US 2015/0030794 A1
(43) Pub. Date: Jan. 29, 2015

(54) ADHESIVE TAPE RELEASE LINER

(71) Applicant: GM GLOBAL TECHNOLOGY OPERATIONS LLC, Detroit, MI (US)

(72) Inventors: Thomas J. Pickett, Warren, MI (US); Matthew E. Carroll, Grosse Pointe Woods, MI (US); Martin P. Sechan, Warren, MI (US)

(73) Assignee: GM GLOBAL TECHNOLOGY OPERATIONS LLC, Detroit, MI (US)

(21) Appl. No.: 13/949,298

(22) Filed: Jul. 24, 2013

(51) Int. Cl. C09J 7/02; B32B 37/26

(52) U.S. Cl. CPC C09J 7/0225; B32B 37/26; B32B 2037/268; B32B 2323/10; B32B 2367/00
USPC 428/41.3; 428/41.8; 156/247

(57) ABSTRACT

An adhesive tape includes a base tape layer, an adhesive layer, and a release liner. The adhesive layer is applied to the base tape layer and includes a tacky surface. The release liner is arranged on the tacky surface, and is also configured for removal from the base tape layer to thereby uncover the tacky surface. The release liner is constructed from a film that is characterized by a microstructure having polymer chains with a multi-axial orientation such that the release liner has substantially equivalent strength in multiple non-parallel directions. A method of affixing a component to a panel via the adhesive tape is also disclosed.

### TECHNICAL FIELD

The present disclosure relates to a release liner for adhesive tape that is used to affix components to panels and structures.

### BACKGROUND

Adhesive tape is frequently employed for affixing various ornamental, protective, and structural components to objects such as interior and exterior panels in vehicles and building structures. Adhesive tape is generally attached to and shipped along with the component that subsequently will become affixed to the host panel.

Such adhesive tape is frequently provided with a release liner that acts as a protective layer in order to shield the adhesive surface of the tape during shipping and handling of the component. Typically, the release liner is configured to be removed from the adhesive tape to uncover the adhesive surface just prior to the component being affixed to the host panel.

### SUMMARY

An adhesive tape is disclosed herein that includes a base tape layer, an adhesive layer, and a release liner. The adhesive layer is applied to the base tape layer and includes a tacky surface. The release liner is arranged on the tacky surface, and is also configured for removal from the base tape layer to thereby uncover or expose the tacky surface. The release liner is constructed from a film that is characterized by a microstructure having polymer chains with a multi-axial orientation such that the release liner has substantially equivalent strength in multiple non-parallel directions.

The polymer chains of the microstructure may have a bi-axial orientation such that the release liner has substantially equivalent strength in two directions.

The release liner may be defined by a width and a length, such that one portion of the polymer chains may be oriented in the direction along the width and another portion of the polymer chains is oriented in the direction along the length.

The release liner may include a pull-tab configured to be drawn for the removal of the release liner from the base tape layer. The pull-tab may be arranged along the length of the release liner.

The film may be constructed from polypropylene (PP) or polyethylene terephthalate (PET).

A method of affixing a component to a panel via the adhesive tape is also disclosed.

The method includes attaching the adhesive tape to the component, removing the release liner from the base tape layer to thereby uncover the tacky surface, and affixing the component to the panel by pressing the tacky surface against the panel.

The panel may be arranged on the exterior of the vehicle body. The panel may be one of a vehicle door, a vehicle rocker panel, and a pick-up truck end gate spoiler and side rail molding.

The panel may also be arranged in the interior of the vehicle body.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic perspective illustration of a motor vehicle having exterior and interior panels with components that are affixed thereto via an adhesive tape according to the disclosure.

FIG. 2 is a schematic perspective illustration of another embodiment of a motor vehicle having exterior panels with components that are affixed thereto via an adhesive tape according to the disclosure.

FIG. 3 is a schematic illustration of a cross-sectional view of the adhesive tape attached to any of the components shown in FIGS. 1 and 2, the tape having a release liner according to an embodiment.

FIG. 4 is a schematic illustration of a top view of the adhesive tape shown in FIG. 1, the tape including a release liner that has a microstructure defined by polymer chains arranged in a bi-axial orientation.

FIG. 5 is a flow chart illustrating a method of affixing a component to a panel (such as shown in FIGS. 1 and 2) via the adhesive tape shown in FIGS. 3 and 4.

### DETAILED DESCRIPTION

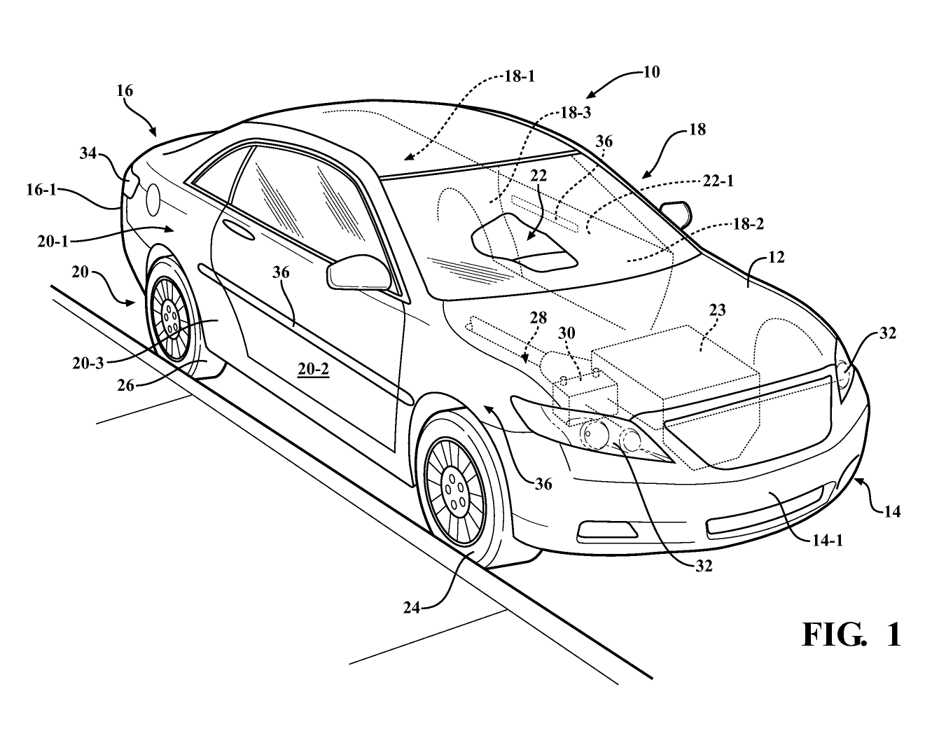

Referring to the drawings, wherein like reference numbers refer to like components, FIG. 1 shows a schematic view of a motor vehicle 10, which includes a vehicle body 12. The vehicle body 12 additionally includes exterior panels positioned at a front end 14, at a rear end 16, as well as at a left body side 18 and at a right body side 20. As shown in FIG. 1, the exterior panel 14-1 is positioned at the front end 14, the exterior panel 16-1 is positioned at the rear end 16, the exterior panel 18-1 is positioned at the left body side 18, and the exterior panel 20-1 is positioned at the right body side 20. The exterior panel 18-1 may include at least one left side door 18-2 and also a left side rocker panel 18-3. Similarly, the exterior panel 20-1 may include at least one right side door 20-2 and also a right side rocker panel 20-3. Although one door is shown in FIG. 1 on each of the exterior panels 18-1 and 20-1, each exterior panel may include any number of doors, as needed.

As shown in FIG. 1, the vehicle 10 also includes an interior 22 configured to accommodate a vehicle operator and passenger(s). The interior 22 includes a plurality of interior panels, including, for example, a panel 22-1 arranged on the interior side of the door 18-2. Although not shown, a similar panel may be arranged on the interior side of the door 20-2. The vehicle 10 additionally includes a powertrain 23 configured to propel the vehicle via front wheels 24, rear wheels 26, or via all four wheels 24 and 26. Furthermore, the vehicle 10 includes an electric system 28 having an energy storage device 30, such as one or more batteries, configured to accept electric charge. The electric system 28 is configured to supply electric current to operate various vehicle systems, such as vehicle head lamps 32, tail lamps 34, a heating, ventilation, and air conditioning (HVAC) system, and a vehicle infotainment system, neither of which are shown, but known to those skilled in the art.

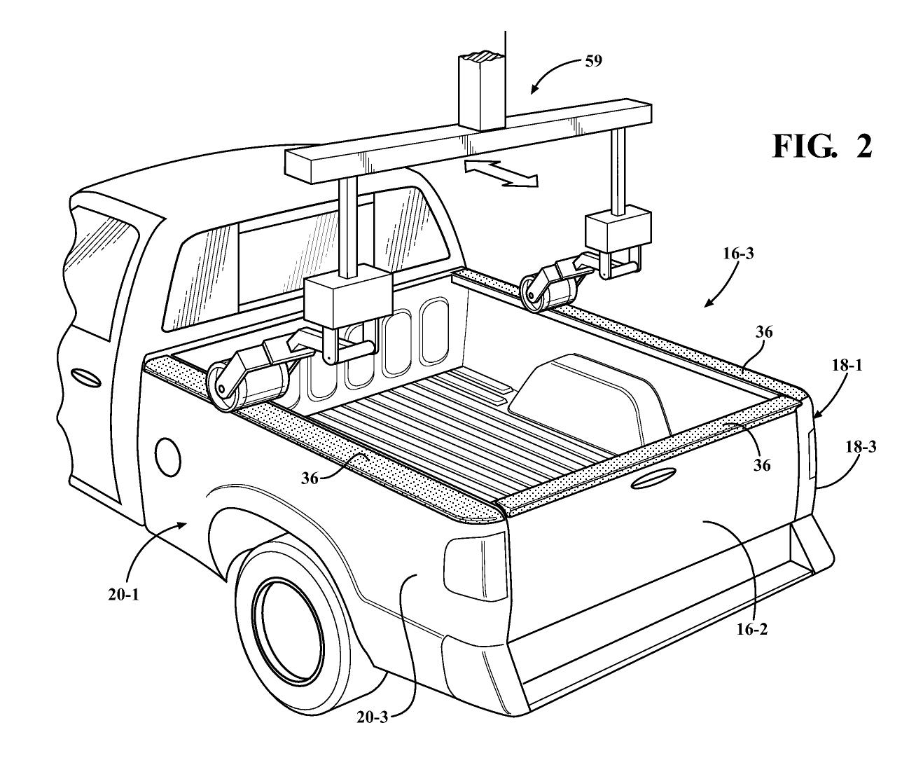

With continued reference to FIG. 1, the vehicle 10 also includes a component 36 that is configured to be attached, i.e., affixed, to a panel such as the panel 18-1, 20-1, or 22-1 via an adhesive tape 38 that is attached to the component. As such, the component 36-1 may be attached to either the left side door 18-2 or the right side door 20-2. The representative component 36 may be a body side molding, which is shown attached to the panel 20-1 in FIG. 1. The vehicle 10 may be configured as a pick-up truck, as shown in FIG. 2. In such a case, the component 36 may be a spoiler for an end-gate 16-2 or an edge guard for a bed 16-3 of the pick-up truck. With resumed reference to FIG. 1, the component 36 may also be an interior trim piece attached to any of the interior panels, such as the panel 22-1, which may be used for functional, as well as ornamental purposes, such as a badge identifying the vehicle model. The above listed versions of component 36 are described only in representative capacity, and are not be seen as limiting the types of components that may be attached via the adhesive tape 38.

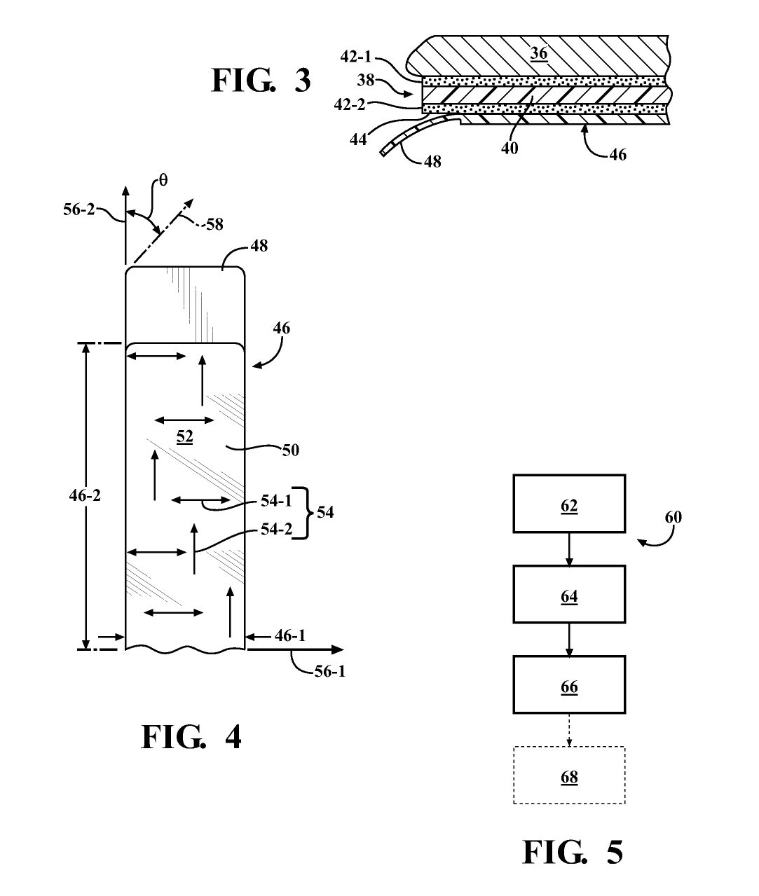

As shown in FIG. 3, the adhesive tape 38 includes a base tape layer 40. The adhesive tape 38 also includes a first adhesive layer 42-1 and a second adhesive layer 42-2, wherein the first and second adhesive layers are applied to opposite sides of the base tape layer 40. The first adhesive layer 42-1 is used to attach the adhesive tape 38 to the component 36, while the second adhesive layer 42-2 includes a tacky surface 44 that needs to be exposed for attachment of the component 36 to the panel 18-1, 20-1, or 22-1. The adhesive tape 38 additionally includes a release liner 46 arranged on the tacky surface 44. The release liner 46 is configured to shield and protect the tacky surface 44 from damage and contamination during handling of the adhesive tape 38 that may reduce the fastening ability of the adhesive tape prior to the component 36 having been affixed to the appropriate panel. The release liner 46 is also designed to be removed from the base tape layer 40 to thereby uncover or expose the tacky surface 44 for affixing the component 36 therewith to the panel 18-1, 20-1, or 22-1. To facilitate removal of the release liner 46 from the base tape layer 40, the release liner includes a pull-tab 48. The pull-tab 48 is configured, i.e., designed and positioned, for being drawn by an individual or a specially configured tool (not shown) in a manufacturing or service environment prior to attachment of the component 36 to the vehicle 10. The release liner 46 is constructed from a film 50 that is characterized by a microstructure 52 having polymer chains 54 with a multi-axial orientation. The multi-axial orientation of the polymer chains 54 making up the microstructure 52 imbues the release liner 46 with substantially equivalent strength in multiple non-parallel directions.

Specifically, as shown in FIG. 4, the polymer chains 54 of the microstructure 52 may have a bi-axial orientation 56, such that the release liner 46 has substantially equivalent strength in two substantially perpendicular directions, i.e., along the first axis 56-1 and a second axis 56-2. The release liner 46 is defined by a width 46-1 which is arranged along the first axis 56-1 and a length 46-2 which is arranged along the second axis 56-2. As may be seen form FIGS. 3-4, one portion 54-1 of the polymer chains 54 is oriented along the width 46-1 and another portion 54-2 of the polymer chains is oriented in the direction along the length 46-2. Accordingly, the microstructure 52 minimizes tendency of the release liner 46 to tear during the removal thereof from the adhesive tape 38, particularly if the release liner is pulled in an oblique direction 58, at an angle (as shown in FIG. 4) relative to the second axis 56-2 prior to the affixing of the component 36 to the panel 18-1, 20-1, or 22-1. For example, the film 50 may be constructed from polypropylene (PP), or polyethylene terephthalate (PET), wherein each of the two materials would be suitable material for generating the necessary multi-axial orientation of polymer chains 54 in the microstructure 52. Each of the polypropylene (PP) and polyethylene terephthalate (PET) are thermoplastic polymers.

Most commercial polypropylene (PP) is isotactic, i.e., a polymer whose constituent molecules give it a repetitive spatial structure. Polypropylene (PP) has an intermediate level of crystallinity between that of low-density polyethylene (LDPE) and high-density polyethylene (HDPE). Polypropylene is normally tough and flexible, especially when copolymerized with ethylene. Such properties allow polypropylene to be used in place of other engineered plastics, such as ABS. Polypropylene can be made translucent, but is often opaque or colored using pigments and has good resistance to fatigue, which makes PP well suited for use in the release liner 46.

The melting point of polypropylene occurs over a temperature a range, so a melting point may be determined by finding the highest temperature of a differential scanning calorimetry chart. Perfectly isotactic PP has a melting point of 171° C. (340° F.). Commercial isotactic PP has a melting point over a range from 160 to 166° C. (320 to 331° F.), depending on the degree to which the material is atactic, i.e., where the substituents of macromolecules of the material are placed randomly along the chain, and material's crystallinity. Syndiotactic or syntactic PP, i.e., where the substituents of the macromolecules of the material have alternate positions along the chain, with a crystallinity of 30% has a melting point of 130° C. (266° F.). Polypropylene (PP) may be manufactured via melt processing. Specifically, melt processing of polypropylene (PP) can be achieved via extrusion and molding. Common extrusion methods include production of melt-blown and spun-bond fibers to form long rolls that may subsequently be used as cut-to-size strips for the release liner 46. The melt flow rate (MFR) or melt flow index (MFI) is a measure of molecular weight of polypropylene. The MFR helps to determine how easily the molten raw material will flow during processing. Polypropylene with higher MFR will fill the plastic mold more easily during the injection or blow-molding production process. As the melt flow increases, however, some physical properties, like impact strength, may decrease.

Depending on the processing and thermal history, commercial polyethylene terephthalate (PET) may exist both as an amorphous (transparent) and as a semi-crystalline polymer. The semi-crystalline material might appear transparent (particle size <500 nm) or opaque and white (particle size up to a few microns) depending on its crystal structure and particle size. The monomer of polyethylene terephthalate (bis-β-hydroxyterephthalate) can be synthesized by an esterification reaction between terephthalic acid and ethylene glycol with water as a byproduct, or by a transesterification reaction between ethylene glycol and dymethyl terephthalate with methanol as a byproduct. Polymerization occurs through a poly-condensation reaction of the monomers (done immediately after esterification/transesterification) with water as the byproduct.

The manufacturing process of polyethylene terephthalate (PET) begins with a film of molten polyethylene terephthalate being extruded onto a chill roll, which quenches the film into the amorphous state. Subsequently, the film is then oriented bi-axially, i.e., along two distinct axes, such as axes 56-1 and 56-2 of the release liner 46, by drawing. The most common way of accomplishing such biaxial orientation is via a sequential process, in which the film is first drawn in the machine direction using heated rollers and subsequently drawn in the transverse direction, i.e., orthogonally, to the direction of travel, in a heated oven. It is also possible to draw the film in both directions simultaneously via specifically designed equipment (not shown). Draw ratios for the PET film are typically around 3 to 4 in each direction.

Once the drawing of the PET film is completed, the film is “heat set” or crystallized under tension in the oven at temperatures typically above 200° C. (392° F.). The heat setting step is designed to prevent the film from shrinking back to its original unstretched shape, while locking in the molecular orientation in the film plane. The orientation of the polymer chains is responsible for the high strength and stiffness of bi-axially oriented PET film, which has a typical Young's Modulus of about 4 Gpa, and makes the PET film well suited for use in the release liner 46. Another important consequence of the molecular orientation is that it induces the formation of multiple crystal nuclei. The crystallites that grow rapidly reach the boundary of the neighboring crystallite and remain smaller than the wavelength of visible light. As a result, despite its semi-crystalline structure, commercially produced bi-axially oriented PET film may display exceptional clarity.

If the bi-axially oriented PET film was produced without any additives, the surface of the film may become so smooth, that layers could adhere strongly to one another when the film is wound up in rolls. To facilitate ease of handling of the release liner 46 produced from PET film, microscopic inert inorganic particles are frequently embedded in the PET to roughen the surface of the film.

FIG. 5 depicts a method 60 of affixing the component 36 to the appropriate panel, such as 18-1, 20-1, or 22-1 in the vehicle 10, via the adhesive tape 38. The method launches in frame 62 with attaching the adhesive tape 38 to the component 36. Following frame 62, the method proceeds to frame 64, where it includes removing the release liner 46 from the base tape layer 40 to thereby uncover the tacky surface 44. After frame 64, the method advances to frame 66, where it includes affixing the component 36 to the appropriate panel by pressing the tacky surface 44 against the panel. Following frame 66, the method may advance to frame 68, where the release liner 46 may be discarded.

As noted above with respect to FIGS. 1-3, the release liner 46 is arranged on the tacky surface 44 for protection of the tacky surface and configured to be removed from the base tape layer 40 to thereby uncover the tacky surface for affixing the component therewith to the panel. As additionally disclosed above with respect to FIG. 4, the release liner 46 is constructed from the film 50 that is characterized by the microstructure 52 having polymer chains 54 with a multi-axial orientation. Such a microstructure facilitates the release liner 46 having substantially equivalent strength in multiple non-parallel directions in order to minimize tearing of the release liner 46 during the removal thereof from the adhesive tape 38 prior to the affixing of the component 36 to the appropriate panel 18-1, 20-1, or 22-1.

After the specific component 36 has been affixed to the appropriate panel 18-1, 20-1, or 22-1, an automated fixture 59 may be used to ensure that the component has indeed fully adhered to the panel. In order to affect the above procedure, the fixture 59 may traverse the surface of the component 36, as shown in FIG. 2.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An adhesive tape comprising:
a base tape layer;
an adhesive layer applied to the base tape layer and having a tacky surface; and
a release liner arranged on the tacky surface and configured to be removed from the base tape layer to thereby uncover the tacky surface;
wherein the release liner is constructed from a film that is characterized by a microstructure having polymer chains with a multi-axial orientation such that the release liner has substantially equivalent strength in multiple directions.

2. The adhesive tape of claim 1, wherein the polymer chains of the microstructure have a bi-axial orientation such that the release liner has substantially equivalent strength in two directions.

3. The adhesive tape of claim 2, wherein the release liner is defined by a width and a length, and wherein one portion of the polymer chains is oriented in the direction along the width and another portion of the polymer chains is oriented in the direction along the length.

4. The adhesive tape of claim 3, wherein the release liner includes a pull-tab configured to be drawn for the removal of the release liner from the base tape layer.

5. The adhesive tape of claim 4, wherein the pull-tab is arranged along the length of the release liner.

6. The adhesive tape of claim 1, wherein the film is constructed from polypropylene (PP).

7. The adhesive tape of claim 1, wherein the film is constructed from polyethylene terephthalate (PET).

8. A method of affixing a component to a panel, the method comprising:
attaching an adhesive tape to the component, wherein the adhesive tape includes:
a base tape layer;
an adhesive layer applied to the base tape layer, wherein the adhesive layer has a tacky surface; and
a release liner arranged on the tacky surface and configured to be removed from the base tape layer to thereby uncover the tacky surface for affixing the component therewith to the panel, wherein the release liner is constructed from a film that is characterized by a microstructure having polymer chains with a multi-axial orientation such that the release liner has substantially equivalent strength in multiple non-parallel directions;
removing the release liner from the base tape layer; and
affixing the component to the panel by pressing the tacky surface against the panel.

9. The method of claim 8, wherein the panel is arranged on the exterior of a vehicle body.

10. The method of claim 9, wherein the panel is one of a vehicle door and a vehicle rocker panel.

11. The method of claim 8, wherein the panel is arranged in the interior of the vehicle body.

12. The method of claim 8, wherein the polymer chains of the microstructure have a bi-axial orientation such that the release liner has substantially equivalent strength in two directions.

13. The method of claim 8, wherein the release liner is defined by a width and a length, and wherein one portion of the polymer chains is oriented in the direction along the width and another portion of the polymer chains is oriented in the direction along the length.

14. The method of claim 13, wherein the release liner includes a pull-tab configured to be drawn for the removal of the release liner from the base tape layer.

15. The method of claim 14, wherein the pull-tab is arranged along the length of the release liner.

16. The method of claim 8, wherein the film is constructed from polypropylene (PP).

17. The method of claim 8, wherein the film is constructed from polyethylene terephthalate (PET).

18. A vehicle comprising:
a vehicle body having a panel;
a component configured to be affixed to the panel via an adhesive tape that is attached to the component;
wherein the adhesive tape includes:
a base tape layer;
an adhesive layer applied to the base tape layer and having a tacky surface;
a release liner arranged on the tacky surface and configured to be removed from the base tape layer to thereby uncover the tacky surface for affixing the component therewith to the panel; and
a pull-tab configured to be drawn for the removal of the release liner from the base tape layer;
wherein the release liner is constructed from a film that is characterized by a microstructure having polymer chains with a multi-axial orientation such that the release liner has substantially equivalent strength in multiple non-parallel directions.

19. The vehicle of claim 18, wherein the panel is one of a vehicle exterior panel and vehicle interior panel.

20. The vehicle of claim 18, wherein the polymer chains of the microstructure have a bi-axial orientation such that the release liner has substantially equivalent strength in two directions.
